(19) United States
(12) Patent Application Publication
(10) Pub. No.: US 2014/0206533 A1
(43) Pub. Date: Jul. 24, 2014

(54) ORGANIC SYRINGOMYCIN METHODS AND COMPOSITIONS

(71) Applicants: Jon Yutaka Takemoto, North Logan, UT (US); Michelle Marie Grilley, Logan, UT (US); Claudia Nischwitz, North Logan, UT (US); Yukie Kawasaki, Logan, UT (US)

(72) Inventors: Jon Yutaka Takemoto, North Logan, UT (US); Michelle Marie Grilley, Logan, UT (US); Claudia Nischwitz, North Logan, UT (US); Yukie Kawasaki, Logan, UT (US)

(73) Assignee: Utah State University, North Logan, UT (US)

(21) Appl. No.: 14/125,551

(22) PCT Filed: Jun. 11, 2012
(86) PCT No.: PCT/US2012/041960

§ 371 Date: Apr. 1, 2014

Related U.S. Application Data
(60) Provisional application No. 61/495,990, filed on Jun. 11, 2011.

(51) Int. Cl. A01N 63/02; A01N 25/30; A01N 47/44

(52) U.S. Cl. CPC A01N 63/02; A01N 47/44; A01N 25/30
USPC 504/100; 435/70.1

(57) ABSTRACT

Methods and materials for producing organic syringomycin, the methods include culturing a culture of Pseudomonas syringae and a growth medium including glucose, mannitol, histidine, a magnesium source, an iron source, and a buffer with a pH of from about 6.5 to 7; extracting syringomycin from the culture to yield an extract; and purifying the extract to yield syringomycin.

### CROSS-REFERENCES TO RELATION APPLICATIONS

This application claims priority to U.S. Provisional Application No. 61/495,990, filed on Jun. 11, 2011, the entirety of which in incorporated herein by reference.

### GOVERNMENT SPONSORED RESEARCH

This invention was made at least in part with government support under the following contracts: DMB 84-05016, DMB 87-04077, INT-8814486, DCB-9003398, and INT-9113416, each awarded by the NSF; and UTG101013-010 awarded by the USDA/Utah Department of Food and Agriculture. The government has certain rights in the invention

### TECHNICAL FIELD

The present disclosure relates to fungicides and their production. More specifically, it relates to syringomycin, its production, its extraction, and its purification from cultures of the plant bacterium Pseudomonas syringae.

### BACKGROUND

The organic farming industry is a fast-growing segment of U.S. agriculture. With accelerated growth, however, come new and larger challenges. Among these challenges is disease management, specifically management of fungal diseases that compromise output and quality. In conventional farming, synthetic fungicides are widely used to reduce fungal diseases. However, effective organic-compatible fungicides are nearly nonexistent.

In the U.S., organic-compatible materials permitted for organic disease control include natural substances, naturally occurring microorganisms, plant extracts, and mined materials, unless they appear as prohibited on the USDA's National List of Allowed and Prohibited Substances. However, effective and economic organic treatment substances are scarce, and candidates from the USDA National List of Allowed and Prohibited Substances have not shown efficacy.

U.S. Pat. No. 5,830,855, incorporated by reference in its entirety, describes methods for using cyclic lipodepsipeptides (CLPs) produced by Pseudomonas syringae to combat plant and mammalian pathogenic fungi.

### SUMMARY

The present disclosure in aspects and embodiments addresses these various needs and problems by providing methods and materials for producing organic syringomycin. The method includes culturing a culture of Pseudomonas syringae and a growth medium comprising glucose, mannitol, histidine, a magnesium source, an iron source, and a buffer at pH 6.5 to 7; extracting syringomycin from the culture to yield an extract; and purifying the extract to yield syringomycin. In addition to these methods and materials, syringomycin-containing seed treatments and seeds treated with composition comprising syringomycin are disclosed.

In some embodiments, the method for producing syringomycin may comprise culturing a culture of Pseudomonas syringae and a growth medium comprising glucose, mannitol, histidine, a magnesium source, an iron source, and a buffer with a pH of from about 6.5 to about 7; extracting syringomycin from the culture to yield an extract; and purifying the extract to yield syringomycin.

In some embodiments, the growth medium may comprise from about 0.5% to about 2% glucose, from about 0.5% to about 2% mannitol, from about 0.2% to about 0.8% histidine, from about 0.4 mM to about 1.6 mM MgSO₄, from about 0.005 mM to about 0.02 mM FeCl₃, and a buffer with a pH of from about 6.5 to about 7;

In some embodiments, the growth medium may comprise from about 0.75% to about 1.5% glucose, from about 0.75% to about 1.5% mannitol, from about 0.3% to about 0.6% histidine, from about 0.6 mM to about 1.2 mM MgSO₄, from about 0.0075 mM to about 0.015 mM FeCl₃, and a potassium phosphate buffer with a pH of from about 6.5 to about 7.

In some embodiments, the growth medium may comprise 1% glucose; 1% mannitol; 0.4% histidine; 0.8 mM MgSO₄; 0.01 mM FeCl₃, and 0.8 mM potassium phosphate buffer, pH 7.

In some embodiments, culturing may comprise agitation and aeration.

In some embodiments, the buffer has a pH of 7.

In some embodiments, the syringomycin is syringomycin E.

In some embodiments, only organic-compatible materials are used.

In some embodiments, extracting comprises adding isopropanol to the culture.

In some embodiments, a supernatant fraction comprising isopropanol and syringomycin is collected.

In some embodiments, purifying comprises running the collected supernatant through high performance liquid chromatography.

In some embodiments, the high performance liquid chromatography comprises isopropanol.

In some embodiments, a seed treated with syringomycin may be produced according to the method outline above.

In some embodiments, a seed may also treated with a rhamnolipid.

In some embodiments, a seed may be treated with a composition comprising organic syringomycin E.

In some embodiments, a seed may be treated with a composition comprising syringomycin E and a rhamnolipid.

In some embodiments, the seed may be treated with a rhamnolipid selected from the group consisting of:

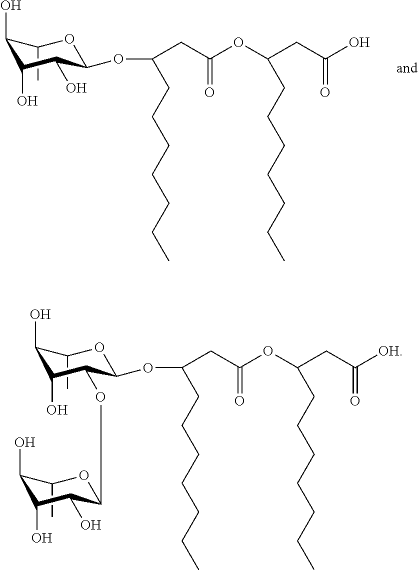

In some embodiments, the seed treatment composition may comprise organic syringomycin E and/or further comprise at least one rhamnolipid.

### BRIEF DESCRIPTION OF THE DRAWINGS

FIG. 1 illustrates a FIG. 1 illustrates the results of a high performance liquid chromatography according to an exemplary embodiment of the disclosure.

FIG. 2 illustrates Pythium ultimum cultured in the absence of syringomycin E according to an exemplary embodiment of the disclosure.

FIG. 3 illustrates Pythium ultimum cultured in the presence of syringomycin E according to an exemplary embodiment of the disclosure.

FIG. 4 illustrates the effect of SRE on germination.

### DETAILED DESCRIPTION

The present disclosure covers apparatuses and associated methods and materials for producing organic syringomycin. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional” or “optionally” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

The present disclosure covers methods, compositions, reagents, and kits for for producing organic syringomycin.

To address the needs in the art for organic fungicides, P. syringae strains, cell growth parameters, fungicide extraction and purification procedures were developed to facilitate P. syringae excretions for use as an organic fungicide.

The plant bacterium P. syringae produces an array of secondary metabolite cyclic lipodepsipeptides (CLPs). The most prevalent CLPs contain an un-branched 3-hydroxy fatty acid connected to the N-terminus of a cationic lactone ring of nine amino acids with molecular weights ranging between 1000 and 1300. The best studied of the CLPs are the syringomycins—particularly the analog syringomycin E (SRE) (shown below).

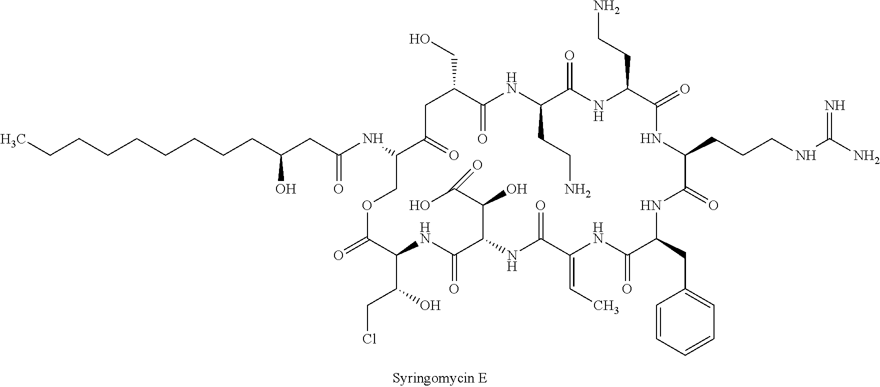

Although SRE is widely considered a plant toxin, this application identifies and recognizes SRE to be an antifungal compound with little or no phytotoxic properties. SRE has potent inhibitory activities against a variety of filamentous fungi, oomycetes, and yeasts. Past studies (i.e. U.S. Pat. No. 5,830,855) focused on the discovery of the CLPs and the antifungal mechanisms of action particularly of SRE.

The antifungal mechanism of action of SRE is the formation of non-ion selective pores in the fungal plasma membrane. A 1 nm diameter lipidic pore is formed that is composed of both SRE and specific fungal sphingolipids. Since fungi possess unique phosphoinositol-containing sphingolipids, SRE's sphingolipid-dependent pore forming mechanism provides an explanation for its preferential action against fungi and not against bacteria or other eukaryotes.

Several pseudomonad bacteria produce and secrete rhamnolipids as secondary metabolites. Rhamnolipids are extracellular glycolipids with powerful surfactant properties. Structurally, they are formed by the linkage of rhamnose to fatty acids of saturated or unsaturated alkyl chain with lengths from C8 to C12. The molecular weights range from 504 to 650 (exemplary rhamnolipids shown below).

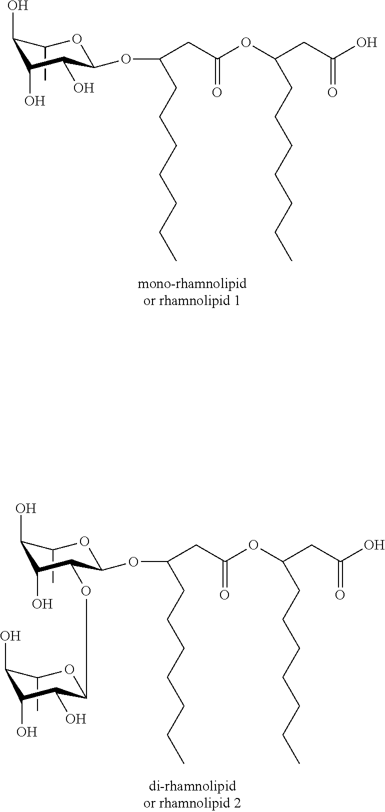

In addition to surface-active properties, the rhamnolipids possess antimicrobial activities. Rhamnolipids inhibit the growth of oomycetes plant pathogens such as Phythium sp. and Phytophthora sp. (unpublished, Table 1). In addition, Haba et al. have shown that rhamnolipids have antibacterial activities against certain Gram-negative and Gram-positive bacteria. Haba et al., Physicochemical characterization and antimicrobial properties of rhamnolipids produced by Pseudomonas aeruginosa 47T2 NCBIM 40044, 81 Biotechnology and Bioengineering 316-322 (2003). Among these are Klebsiella pneumoniae, Enterobacter aerogenes, Bacillus subtilis and Micrococcus luteus. Curiously, rhamnolipids are not active against yeasts and most true filamentous fungi.

A variety of yeasts, oomycetes and true fungi have been tested including a complex of fungi associated with diseased grapes. Examples of tested organisms are presented in Table 1 below.

TABLE 1
Antifungal activities of SRE, rhamnolipid, and SYRA

| | ¹MIC (mg mL⁻¹) | | |
|---|---|---|---|
| Fungus | SRE | Rh | SRE in SYRA |
| Aspergillus flavus | 7.8 | >375 | 3.9 |
| Rhodotorula pilimanae | 3.9 | 93.8 | 0.98 |
| Candida albicans | 3.9 | >375 | 1.95 |
| Rhizopus stonifer | 7.8 | >375 | 3.9 |
| Fusarium oxysporum | 7.8 | >375 | 3.9 |
| Penicillium sp1 | 7.8 | >375 | 7.8 |
| Botrytis cinera | 3.9 | 93.8 | 0.98 |
| Rhizoctonia solani | 3.9 | >375 | 1.95 |
| Cladosporium sp | 3.9 | >375 | 1.95 |
| Penicillium sp2 | 7.8 | >375 | 1.95 |
| Pythium ultimum | 7.8 | 23.5 | 0.98 |
| Phytophora parasitica | 7.8 | 23.5 | 1.95 |

¹Values were obtained from at least two replicate experiments. Growth incubation was 2 to 5 days at 28° C.

Rhamnolipids alone did not display inhibitory activities against true fungi or yeast as previously reported. SRE and a defined mixture of SRE and rhamnolipids (termed SYRA) showed potent fungicidal activities against all fungi, oomycetes, and yeasts tested. When mixed with rhamnolipids in SYRA, the MICs based on the concentration of the SRE component were 2 to 5 fold lower (i.e. more active) than with SRE alone for all fungi and yeast tested (Table 1).

Thus, in the SYRA formulation rhamnolipids appear to enhance the fungicidal activities of SRE. SYRA's inhibitory activities against F. oxysporium, B. cines, R. solani and oomyctes species of Pythium and Phytophora are of particular interest for considering SYRA as a seed treatment. These organisms are often seed borne and the primary root rot pathogens of vegetable seedlings. For example, the vegetable organic farming industry of the Pacific Northwest is currently experiencing a serious and growing problem with Pythium spp. (mainly P. ultimum) and R. solani which are the main culprits in damping off of seeds and seedlings. U.S. 2007/0191292 to Gandhi et al., the entire disclosure incorporated herein by reference, describes rhamnolipid formulations with non-organic SRE.

Also, SYRA has properties that are desirable for a seed treatment substance. It is: 1) in liquid form suitable for soil drenching and seed slurry treatments, 2) heat stable up to 60° C., 3) not inactivated by ultraviolet light, 4) stable for weeks at room temperature, and 5) does not inhibit the germination of vegetable seeds.

There are, however, limitations to overcome for developing SYRA applications in seed treatments. The most significant is the availability of suitable amounts of organic-compatible SRE. SRE is currently produced conventionally using chemical solvents. Alternative production methods that are organic-compatible must be adopted. In contrast, large quantities of organic rhamnolipids are now produced commercially using fermentative processes (Jeniel Biosurfactant, Wisconsin). This disclosure sets forth alternative production methods for organic syringomycin.

Methods disclosed herein comprise producing, extracting, and purifying CLPs from bacterial sources, specifically SRE from P. syringae.

### I. PRODUCTION

Any suitable strain of P. syringae may be used to produce SRE. Exemplary strains include B301D, as well as other strains capable of producing SRE, or any other desired CLP.

In growing the bacteria, any suitable procedure or medium may be used. Preferably, the growth procedures and medium incorporate the use of allowed organic substances and avoid substances that are not organic-compatible.

In embodiments, an “Improved Syringomycin Culture Medium (ISM)” is used. The ISM results in increased yields of SRE amounts in aerated and agitated cultures when compared with previously used growth media which require non-agitated conditions for SRE production. ISM is a chemically defined medium containing organic-compatible components and yields>100 mg of SRE L⁻¹ of culture.

Exemplary ISM growth medium may contain the following components in the listed percentages or mM concentrations:
A sugar, such as glucose, in an amount of from about 0.5% to about 2%, such as from about 0.75% to about 1.5%, or about 1%;
A sugar alcohol, such as mannitol, in an amount of from about 0.5% to about 2%, such as from about 0.75% to about 1.5%, or about 1%;
An amino acid, such as histidine, in an amount of from about 0.2% to about 0.8%, such as from about 0.3% to about 0.6%, or about 0.4%;
A magnesium source, such as magnesium salts (exemplary magnesium sources may include MgSO₄, MgS, and MgCl₂), in an amount of from about 0.4 mM to about 1.6 mM, such as from about 0.6 mM to about 1.2 mM, or about 0.8 mM; preferred magnesium sources include MgSO₄;
An iron source, such as iron salts or iron chelates (exemplary iron sources may include FeCl₃, EDTA, EDDHA, FeSO₄), in an amount of from about 0.005 mM to about 0.02 mM, such as from about 0.0075 mM to about 0.015 mM, or about 0.01 mM; preferred iron sources include FeCl₃.

These components are mixed in a buffer with a pH of from about 6.5 to about 7.0. Any suitable buffer may be used. Exemplary buffers include potassium phosphate buffers, sodium phosphate buffers, and HEPES buffer. In some embodiments, a 0.8 mM potassium phosphate buffer is used.

Fermentative production of SRE using ISM may be done in any suitable reactor with controlled temperature, aeration, and agitation capabilities. Exemplary reactors include, Virtis Omniculture and New Brunswick Bioflo 310 4 L-capacity vessels. Other reactors with larger capacities may be used.

SRE levels and activities may be monitored by high-performance liquid chromatography (HPLC) and bioassay, respectively. For example, for both determinations, 500 μL of the culture may be mixed with 500 μL of acidified acetone (0.4% HCl in acetone, centrifuged, and 200 μL of the supernatant fluid recovered. For HPLC, 10 to 50 μL aliquots may be chromatographed using C-18 reverse phase silica columns and 0 to 80% isopropanol gradients in 0.1% TFA. Peak absorbances may be monitored at about 340 nm. For bioassays, aliquots of culture extracts may be deposited into wells of a Corning ceramic plate and evaporated to a small oil residue. The residue may be resuspended in sterile distilled water, 2-fold serial dilutions made, and the suspensions (8 μL) will be spotted onto the surfaces of potato dextrose+0.4% casamino acids (PD-CA) medium agar plates with a freshly spread lawn of Rhodotorula pilimanae. After 24 h incubation at room temperature, cleared zones of growth inhibition may be observed, and SRE activities quantitated on the basis of dilution end-point inhibition. When the SRE production rate reaches a maximum as judged by HPLC and bioassay, the cultures may be harvested and SRE extracted as described below.

### II. EXTRACTION

Any suitable extraction processes and materials may be used to extract the SRE from the culture. As with the growth procedures and medium, extraction materials are preferably organic-compatible. In particular, the extraction process uses isopropanol, an organic-compatible substance. Isopropanol is listed as an allowed synthetic substance for use in organic crop production. See USDA, National Organic Program, Sunset Review, in U. A. M. Service (ed.), vol. 72 Federal Register (2007). Previously used SRE extraction procedures used acetone, which is not on the allowed organic substance list. Bidwai & Takemoto, Bacterial phytotoxin, syringomycin, induces a protein kinase-mediated phosphorylation of red beet plasma membrane polypeptides, 84 Proc. Natl. Acad. Sci. 6755-6759 (1987) (incorporated by reference in its entirety).

In embodiments, SRE-containing cultures may be chilled to, for example, 4° C. and mixed 1:1 (by volume) with isopropanol and stirred in the cold for a minimum of 2 h. The cell debris may be removed by centrifugation (e.g. Beckman JA10 rotor, 7,000 rpm, 20 min). The supernatant, may be concentrated by rotary flash evaporation, the volume adjusted with isopropanol to make a final concentration of 60% isopropanol by volume, and the suspension stirred gently overnight at, for example, 4° C.

After centrifugation, the supernatant fraction may be flash evaporated to eliminate isopropanol, and the volume adjusted with distilled water to give 0.75 L 4 L-1 of original culture.

### III. PURIFICATION

Any suitable purification processes and materials may be used to purify the extract. As with the other procedures and materials, purification materials are preferably organic-compatible. As with the extraction process, isopropanol is again preferably used.

The extract may be applied to an Amberlite XAD-2 column and eluted with a step gradient of 20%, 70%, and 100% isopropanol in succession. Fractions may be collected and tested for antifungal activities against R. pilimanae as described above in the production section. The active fractions may be pooled, flash evaporated, lyophilized, and dissolved in 60% isopropanol in water. This solution may then be subjected to high performance liquid chromatography (HPLC) on a semi-preparative C18 silica reverse phase column with a linear gradient of 0-100% isopropanol. SRE has a retention time equivalent to ˜50% isopropanol. SRE peak materials from multiple chromatographic runs may be collected, pooled, assayed, lyophilized to dryness, and designated “organic SRE”.

### IV. ORGANIC SYRA

Organic SYRA may be prepared from organic SRE produced by the processes described above and rhamnolipids I and II as previously described. Suitable rhamnolipids may be obtained from a commercial source, Zonix™ biofungicide from Jeneil Biosurfactant.

To make organic SYRA, organic SRE may be mixed with rhamnolipids in any suitable ratio, such as from about 1:6 to about 2:1 (SRE:rhamnolipid, by weight), or from about 1:4 to about 1:2, such as about 1:3.

Organic SYRA may be used against fungi, including, for example, F. oxysporium, B. cines, R. solani and P. ultimum. To test these and other various fungi, the fungi may be grown in PDB-CA medium for 48 h at 28° C. with aerobic shaking. For disk diffusion growth inhibitory assays, the culture densities may be adjusted to 108 CFU mL-1 and the cultures spread-plated on PD-CA agar plate medium surfaces. Sterilized paper disks (0.5 cm diameter) may be placed on the inoculated agar medium surfaces. Eight μL aliquots of SYRA solutions may be applied to the disks, and the plates incubated for 16 to 24 h at 28° C. before examination and measurement of the diameters of the cleared zones of inhibition. Microbroth dilution assays for determination of minimal inhibitory concentrations (MICs) may be conducted in sterile, flat-bottomed 96-well microtiter plates. SYRA may also be serially diluted in the range of 500 to 1 μg mL-1 SRE equivalent concentration in PDB-CA growth medium and each well inoculated with 10 μL of fungal culture. Negative and positive controls may be tests with water and widely used conventional fungicide metalaxyl, respectively, instead of SYRA.

### V. SEED TREATMENTS

Seeds may be treated with CLPs such as SRE or active mixtures, such as SYRA, or a combination of one or more CLP's. In embodiments, seeds may be treated in a slurry of SYRA at a concentration of, for example, 2¹, 2², 2⁰, and 2⁻¹. The slurry may comprise SYRA and a liquid, such as water or another solvent. In examples, seeds may be treated to prevent pre- and post-germination damping off, seedling root rot or wilt caused by fungi, such as, F. oxysporium, B. cines, R. solani and P. ultimum.

In other embodiments, the seeds may be coated with a mixture comprising SYRA and a biodegradable, organic adhesive or polymer.

Suitable plant seeds for treatment include the seeds of, for example, grains, fruits, and vegetables such as, for example, cucurbits, squashes, melons, cucumbers, corn, barley, rice, wheat, oats, soybeans, sorghum, cotton, alfalfa, peanuts, coffee, and tomatoes.

### VI. EXAMPLES

### Example 1

### Bacterial Strain Development

Although the methods described herein may be applied generally to P. syringae strains, such as strain B301D, bacterial strains with increased ability to produce CLPs, specifically SRE were developed to improve SRE output.

Strain B301D was exposed to ultraviolet radiation for 10-20 seconds. The radiated strains were parsed out and tested for SRE production. A prominent SRE producer (strain G10) was identified from the mutagenized pool.

### Example 2

### Fungicide Production

Strain G10 was grown in 1 L of improved syringomycin culture medium (ISM) in an Omni-culture (VirTis) bioreactor. ISM yields SRE amounts that are superior to previously used growth medium. The medium includes 1% glucose, 1% mannitol, 0.4% histidine, 0.8 mM MgSO₄, and 0.01 mM FeCl₃ in 0.8 mM potassium phosphate buffer (pH 7.0). The culture was agitated and aerated (previous production methods occurred only in non-aerated, still cultures. SRE was detected in 24-48 hours by R. pilimanae bioassay.

### Example 3

### Extraction and Purification

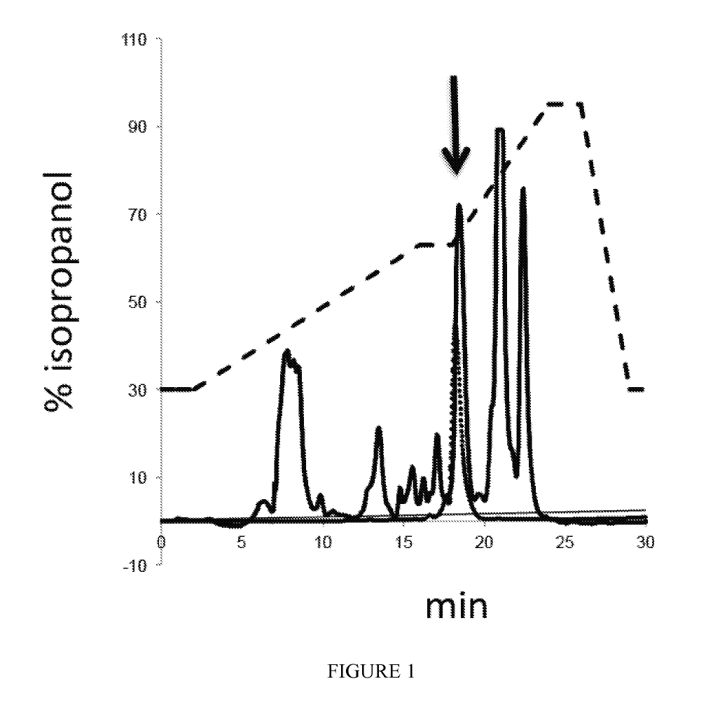

The SRE culture and the foamy material that accumulates above the culture surface were extracted with isopropanol+4% acetic acid. This crude extraction was subjected to Amberlite XAD-2 chromatography and HPLC on a C18 silica reverse phase column. FIG. 1 illustrates the results of the HPLC purification step. Specifically, FIG. 1 illustrates HPLC profiles of G10 cell extract containing organic SRE (solid line) and authentic SRE standard (dotted line) obtained using an isopropanol solvent gradient (dashed line). The arrow shows the peak with antifungal activity. In FIG. 1, the peak that had Rf value of 18 min and showed activity with bioassay against R. pilimanae was collected. After lyophilization, about 50 mg l⁻¹ of SRE was obtained from the growth culture. Approximately 50% of the SRE produced was recovered after extraction and chromatographic purification using organic-compatible isopropanol throughout the process.

### Example 4

### Testing In Vitro Antifungal Activity

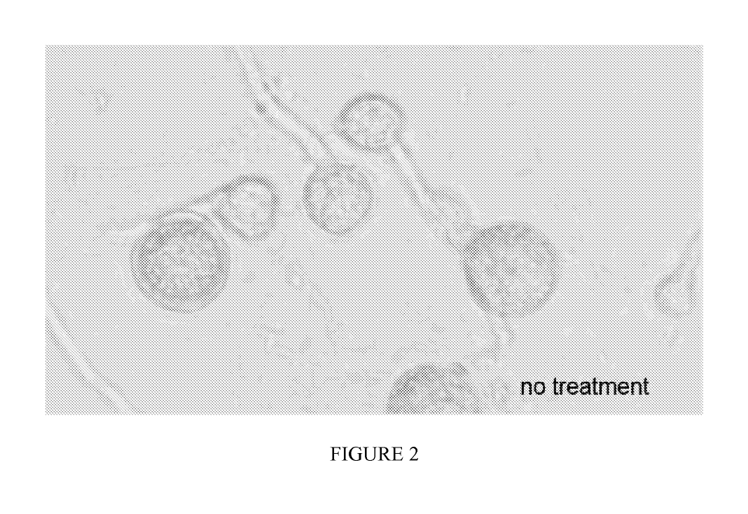

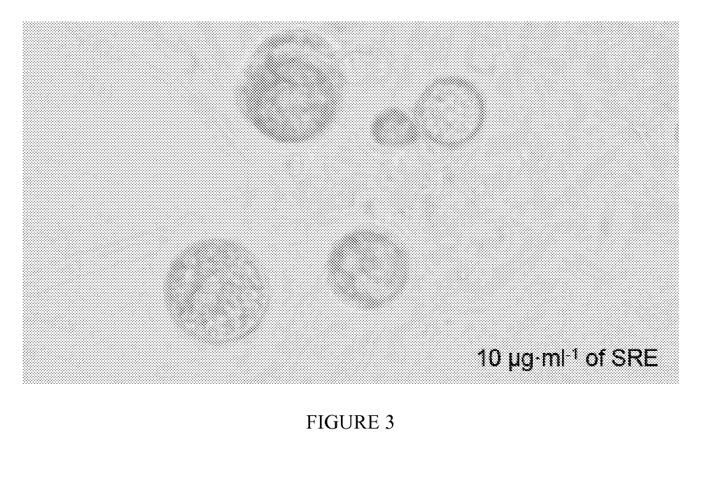

Pythium ultimum oospores were incubated in water with the purified SRE of Example 3 and observed for germination. FIGS. 2 and 3 illustrate that germination of the oospores was inhibited when treated with the purified SRE. In FIG. 2, the oospores were incubated without addition of the SRE. Germination occurs. In FIG. 3, the oospores were incubated with 10 μg ml⁻¹ of SRE. Under these modified conditions, Pythium oospore germination does not occur.

These examples illustrate the efficacy of the methods and materials described herein. Strain G10 growth in ISM yielded approximately 50 mg l⁻¹, which is two to three times higher than previously reported yields using conventional methods. In addition, the production time was reduced from 10 days to 48 hours. Finally, the purified SRE effectively inhibited the growth of P. ultimum, an exemplary problematic pathogen in agriculture.

### Example 5

### Effect of SRE on Seed Germination

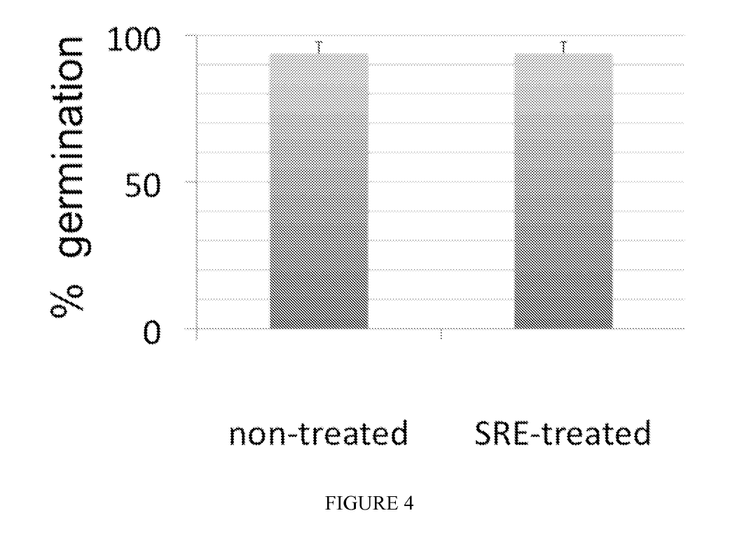

Untreated cucumber seeds were coated with a 4 mL solution composed of 2.5 mg of SRE, 0.2 g of starch, and water. The seeds were air-dried and then sown in potting soil (1 seed per pot). Untreated seeds were sown directly into potting soil. Germination was defined as a seedling achieving the two-leaf stage. FIG. 4 illustrates the results shown are from six separate experiments and six seeds per experiment.

The above described methods, materials, and examples may be applied to various embodiments not specifically described herein.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method for producing syringomycin, the method comprising:
culturing a culture of Pseudomonas syringae and a growth medium comprising
glucose,
mannitol,
histidine,
a magnesium source,
an iron source, and
a buffer with a pH of from about 6.5 to about 7;
extracting syringomycin from the culture to yield an extract; and
purifying the extract to yield syringomycin.

2. A method according to claim 1, wherein the growth medium comprises
from about 0.5% to about 2% glucose,
from about 0.5% to about 2% mannitol,
from about 0.2% to about 0.8% histidine,
from about 0.4 mM to about 1.6 mM MgSO₄,
from about 0.005 mM to about 0.02 mM FeCl₃, and
a buffer with a pH of from about 6.5 to about 7;

3. A method according to claim 1, wherein the growth medium comprises
from about 0.75% to about 1.5% glucose,
from about 0.75% to about 1.5% mannitol,
from about 0.3% to about 0.6% histidine,
from about 0.6 mM to about 1.2 mM MgSO₄,
from about 0.0075 mM to about 0.015 mM FeCl₃, and
a potassium phosphate buffer with a pH of from about 6.5 to about 7.

4. A method according to claim 1, wherein the growth medium comprises
1% glucose;
1% mannitol;
0.4% histidine;
0.8 mM MgSO₄;
0.01 mM FeCl₃, and
0.8 mM potassium phosphate buffer, pH 7.

5. A method according to claim 1, wherein the culturing comprises agitation and aeration.

6. A method according to claim 1, wherein the buffer has a pH of 7.

7. A method according to claim 1, wherein the syringomycin is syringomycin E.

8. A method according to claim 1, wherein only organic-compatible materials are used.

9. A method according to claim 1, wherein extracting comprises adding isopropanol to the culture.

10. A method according to claim 9, wherein a supernatant fraction comprising isopropanol and syringomycin is collected.

11. A method according to claim 10, wherein purifying comprises running the collected supernatant through high performance liquid chromatography.

12. A method according to claim 11, wherein the high performance liquid chromatography comprises isopropanol.

13. A seed treated with syringomycin produced according to the method of claim 1.

14. A seed according to claim 13, wherein the seed is also treated with a rhamnolipid.

15. A seed treated with a composition comprising organic syringomycin E.

16. A seed according to claim 15, wherein the composition further comprises a rhamnolipid.

17. A seed according to claim 16, wherein the rhamnolipid is selected from the group consisting of:

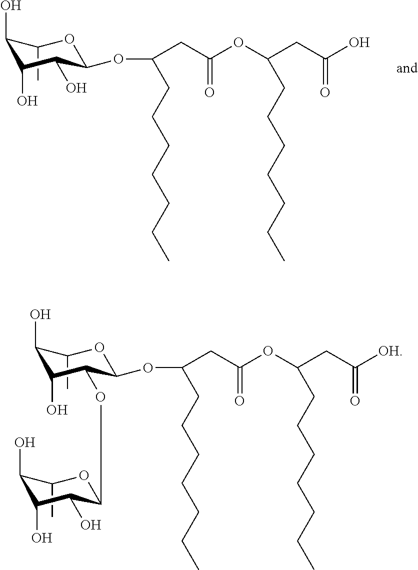

18. A seed treatment composition, comprising organic syringomycin E.

19. A seed treatment composition according to claim 18, further comprising at least one rhamnolipid.
